(19) United States
(12) Patent Application Publication
(10) Pub. No.: US 2013/0255539 A1
(43) Pub. Date: Oct. 3, 2013

(54) Composition for Polymer Systems

(71) Applicants: Zoran Brdarski, Copley, OH (US); Shirley Neal Kendall, Akron, OH (US); Michael Thomas Mikolay, Macedonia, OH (US)

(72) Inventors: Zoran Brdarski, Copley, OH (US); Shirley Neal Kendall, Akron, OH (US); Michael Thomas Mikolay, Macedonia, OH (US)

(21) Appl. No.: 13/435,132

(22) Filed: Mar. 30, 2012

(51) Int. Cl. C08K 5/17

(52) U.S. Cl. 106/502; 106/505; 524/186

(57) ABSTRACT

The present invention concerns a composition and method of using adipamides in polymer applications. The composition is a blend of multi-components comprising dicarboxylic acids and amines. Specifically, the composition comprises adipic acid and monoethanolamine. The composition can further comprise at least one of the following: amides, esters, antioxidants, waxes, metal soaps, copolymers, polyesters, or fillers. However, these components are not necessary, and the composition can be utilized without these components. The composition is typically prepared in a cold reactor, wherein nitrogen flow is started and the temperature is increased gradually to approximately 360° F. Further, the disclosed composition reduces viscosity in polymer products, aids in melt integrity and process extrusion and promotes better mold release than conventional additives.

### BACKGROUND OF THE INVENTION

1. Field of the Invention

This invention is related to a composition and method of using adipamides in polymer applications.

2. Description of Related Art

Polymers, such as nylon are usually processed in a melt. The associated changes in structure and state (e.g. crosslinking, oxidation, molecular weight changes) cause some alteration in the chemical, physical, and technical properties of almost all polymers. To reduce the stress to which polymers are exposed during processing, various additives are used, among which are stabilizers, lubricants, antioxidants, release agents, dispersing agents, impact modifiers, fillers, property enhancers, and others.

Conventional processing aids typically include montan wax and ester type lubricants. However, it is difficult to control the breakdown of the montan wax emulsion, thus viscosity is increased and melt integrity, process extrusion, and mold release are hindered. In addition, montan wax can be quite expensive and difficult to locate. Accordingly, there is a need for a composition that out-performs montan wax and ester type lubricants and that offers a distinctive price/performance advantage.

The current invention provides for a composition and method of using adipamides in polymer applications. The disclosed composition reduces viscosity in polymer products, aids in melt integrity and process extrusion and promotes better mold release than conventional additives. Furthermore, the same composition and method of using adipamides can also be employed in other polymer applications, as is known by a person of ordinary skill in the art.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The present invention concerns a composition and method of using adipamides in polymer applications. The composition is a blend of multi-components comprising dicarboxylic acids and amines. Specifically, the composition comprises adipic acid and monoethanolamine. The composition can further comprise at least one of the following: amides, waxes, esters, antioxidants, metal soaps, copolymers, polyesters, or fillers. However, it is also contemplated that the composition can be utilized without these components. The disclosed composition reduces viscosity in polymer products, aids in melt integrity and process extrusion and promotes better mold release than conventional additives.

The composition comprises the listed multi-components, which are preferably mixed in a cold reactor in a nitrogen atmosphere. Specifically, in a preferred embodiment, the composition is comprised of a blend of dicarboxylic acids, amines, and at least one of amides, waxes, esters, antioxidants, metal soaps, copolymers, polyesters, or fillers. Typically, the composition is prepared in a cold reactor, wherein nitrogen flow is started and the temperature is increased gradually from approximately 70° F. to approximately 360° F. The final product can then be extruded at approximately 250°-400° F. The yield of the final extruded composition is typically in the range of 65-85% by weight.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a graph of the Melt Index of the composition in accordance with the disclosed invention.

FIG. 2 illustrates a graph of the Spiral Flow Data of the composition in accordance with the disclosed invention.

FIG. 3 illustrates a graph of an Infrared Spectrum of the composition in accordance with the disclosed invention.

FIG. 4 illustrates a graph of a Viscosity Curve of the composition in accordance with the disclosed invention.

### DESCRIPTION OF PREFERRED EMBODIMENTS

Approximating language, as used herein throughout the specification and claims, may be applied to modify any quantitative representation that could permissibly vary without resulting in a change in the basic function to which it is related. Accordingly, a value modified by a term or terms, such as “about”, is not limited to the precise value specified. In at least some instances, the approximating language may correspond to the precision of an instrument for measuring the value. Range limitations may be combined and/or interchanged, and such ranges are identified and include all the sub-ranges stated herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

As used herein, the terms “comprises”, “comprising”, “includes”, “including”, “has”, “having”, or any other variation thereof, are intended to cover a non-exclusive inclusion. For example, a process, method, article or apparatus that comprises a list of elements is not necessarily limited to only those elements, but may include other elements not expressly listed or inherent to such process, method, article, or apparatus.

The singular forms “a”, “an”, and “the” include plural referents unless the context clearly dictates otherwise.

To reduce the stress to which polymers are exposed during processing, various additives are used, among which are stabilizers, lubricants, antioxidants, release agents, dispersing agents, and others. Conventional additives typically include montan wax, ester type lubricants, metal soaps, ethylene bis stearamide (EBS), and/or other processing aids known in the industry relative to the specific type of polymer being processed. However, it is difficult to control the breakdown of the montan wax emulsion and other additives, thus viscosity is increased and melt integrity, process extrusion, and mold release are hindered. In addition, montan wax can be quite expensive and difficult to locate. The current invention provides for a composition and method of using adipamides in nylon and other polymer applications. The disclosed composition reduces viscosity in nylon products and other polymer applications, aids in melt integrity and process extrusion and promotes better mold release than conventional additives.

Accordingly, disclosed is a composition and method of using adipamides in nylon and other polymer applications. The composition is preferably a blend of multi-components comprising dicarboxylic acids, amines, and at least one of amides, waxes, esters, antioxidants, metal soaps, copolymers, polyesters, or fillers. Typically, the composition is prepared in a cold reactor, wherein nitrogen flow is started and the temperature is increased gradually from 70° F. to approximately 280-420° F. It is contemplated that other temperatures outside of the above stated range can be used if a vacuum is employed. The final product can then be extruded at approximately 250-400° F. It is contemplated that other temperatures outside of the range can be used depending on the different types of forming employed. The yield of the final extruded composition is typically in the range of 65-85% by weight. However, other ranges can be used as is known in the art, without affecting the overall concept of the invention. Additionally, the process is not limited to extrusion, and other types of forming can be used, such as but not limited to, spray tower, casting, etc.

The polymer additive composition comprises dicarboxylic acid and an amine. The dicarboxylic acid comprises a molecular weight of about 118 to 174, and contains from about 4 to 8 carbon atoms. The dicarboxylic acid comprises the formula: HOOC—R—COOH. The amine comprises a molecular weight of about 61 to 145, and comprises the formula R′—NH2 or OH—R″—NH2. Furthermore, the claimed ranges of the components in the composition, as active ingredients, include dicarboxylic acid at a range of about 30-65% by weight, and an amine at a range of about 35-55% by weight. Specifically, the composition, as active ingredients, comprises: adipic acid and monoethanolamine. However, other acids can be used, such as butanedioic acid, pentanedioic acid, heptanedioic acid, or octanedioic acid. Further, other amines can be used as well, such as ethanolamines, heptaminol, or propanol amines.

Optionally, the composition can further comprise at least one of amides, esters, antioxidants, waxes, metal soaps, copolymers, polyesters, or fillers. Further, the at least one of amides, esters, antioxidants, waxes, metal soaps, copolymers, polyesters, or fillers are present in the composition in a range of about 0.5-15% by weight. Specifically, the solution comprises: at least one of amides such as ethylene bis lauramide, ethylene bis stearamide (EBS), oleamid, stearmid, erucamid, and copolymers of ethylene vinyl acetate; esters such as pentaerythritol tetrastearate, stearylstearate, pentaerythritol adipate-stearate, and distearylphthaloate; antioxidants such as distearyl thiodipropionate (DSTDP), dilauryl thiodipropionate (DLTDP), BNX1225®, Irganox 1010®, and Irganox 1076®; waxes such as Paraflint H-1® wax, Vestowax SH-105®, PEH-100®, Sasolwax H1®, Deurex E08®, and Deurex E12®; metal soaps such as zinc-stearate, calcium-stearate, zinc laurate, potassium stearate, and magnesium stearate; copolymers such as ethylene vinyl acetate (EVA), ionomers; polyesters such as polyethylene adipate diol (PEA); or fillers such as silica, calcium-carbonate, talc, zeolites. Furthermore, it is well understood by a person of skill in the art, that the additives and the ratios of the individual components of this composition can vary widely to obtain the desired physical properties and production quality. Also variable is the type of equipment employed, the cost of manufacturing, and the performance of the product.

Generally, the composition has a dropping point range of about 105-120° C., a specific gravity range of about 1.20-1.35, an acid value (AV) range of about 4-10, wherein the acid value is the amount of potassium hydroxide (KOH) in milligrams that is required to neutralize one gram of the chemical composition, and a viscosity range of about 10-150 cPs. The basic chemical reaction for the composition is between the carbonyl group of an acid with an amino group from an amine resulting in an amide.

The present disclosure will now be described more specifically with reference to the following examples. It is to be noted that the following examples are presented herein for purpose of illustration and description; they are not intended to be exhaustive or to limit the disclosure to the precise form disclosed.

### EXAMPLE 1

This example demonstrates that the use of adipamides for polymer applications discloses better performance than the conventional polymer additives, especially with melt integrity, process extrusion, viscosity, and mold release.

In this test example, a cold reactor is used. The formulations (E1-E6) disclosed in Table 1 are prepared in separate cold reactors for quality control. For example, formulations E1-E6 comprise approximately 45.5% by weight of monoethanolamine and approximately 54.5% by weight of adipic acid. First, the total amount of monoethanolamine is added into the cold reactor. Nitrogen flow is then started and the mixer is turned on. The required amount of adipic acid is then slowly added to the reactor. The product temperature is then set at approximately 300° F. For the first hour of the reaction, the condenser column is kept on the top of the reactor, which prevents any loss of monoethanolamine. Then, the temperature is gradually increased to approximately 360° F. The reaction is then run through the condenser. Once the product reaches a temperature of approximately 360° F., the reaction temperature is kept at approximately 360° F. and the reaction is run until the AV<10. The product is then extruded at an approximate temperature of 260° F. and measured (See results in Table 2).

Each of formulations (E1-E6) is prepared in separate cold reactors following the same test procedures as described above. The final product is then extruded and measured and the results recorded in Table 2.

TABLE 1
Experimental Formulations

| | Formulations | | | | | |
|---|---|---|---|---|---|---|
| | E1 | E2 | E3 | E4 | E5 | E6 |
| Mono- | 45.5% | 45.5% | 45.5% | 45.5% | 45.5% | 45.5% |
| ethanolamine | | | | | | |
| Adipic Acid | 54.5% | 54.5% | 54.5% | 54.5% | 54.5% | 54.5% |

TABLE 2
Test Results

| Treatment Solutions | Acid Value (AV) | Amine Value | Drop Point (° C.) |
|---|---|---|---|
| E1 | 7.3 | 14.6 | 119.5 |
| E2 | 6.7 | 15.3 | 120.7 |
| E3 | 8.5 | 16.2 | 115.2 |
| E4 | 8.2 | 15.2 | 121.0 |
| E5 | 8.3 | 15.6 | 121.0 |
| E6 | 8.6 | 16.4 | 119.7 |

As can be seen, the test parameters were used for detecting quality of product and repeatability of the manufacturing process, especially with regard to acid value, amine value and drop point.

### EXAMPLE 2

This example demonstrates that the use of adipamides for polymer applications discloses better performance than the conventional polymer additives, especially with melt integrity, process extrusion, viscosity, and mold release.

In this test example, a cold reactor is used. The formulations (E7-E11) disclosed in Table 3 are prepared in separate cold reactors for quality control. For example, formulations E7-E11 comprise 45.07% by weight of monoethanolamine, 53.98% by weight of adipic acid, and 0.95% by weight of a paraffin wax structure. First, the total amount of monoethanolamine is added into the cold reactor. Nitrogen flow is then started and the mixer is turned on. The required amount of adipic acid is then slowly added to the reactor. The product temperature is then set at approximately 300° F. For the first hour of the reaction, the condenser column is kept on the top of the reactor, which prevents any loss of monoethanolamine. Then, the temperature is gradually increased to approximately 360° F. The reaction is then run through the condenser. Once the product reaches a temperature of approximately 360° F., the reaction temperature is kept at approximately 360° F. and the reaction is run until AV<10. When then AV<10 the at least one of amides, waxes, esters, antioxidants, metal soaps, copolymers, polyesters, or fillers is added. The product is then extruded at approximately 260° F. and measured (See results in Table 4).

Each of formulations (E7-E11) is prepared in separate cold reactors following the same test procedures as described above for quality control. The final product is then extruded and measured and the results recorded in Table 4.

TABLE 3
Experimental Formulations

| Formulations | E7 | E8 | E9 | E10 | E11 |
|---|---|---|---|---|---|
| Monoethanolamine | 45.07% | 45.07% | 45.07% | 45.07% | 45.07% |
| Adipic Acid | 53.98% | 53.98% | 53.98% | 53.98% | 53.98% |
| At least one of: | 0.95% | 0.95% | 0.95% | 0.95% | 0.95% |
| Amides, Waxes, | | | | | |
| Esters, Antioxidants, | | | | | |
| Metal Soaps, | | | | | |
| Copolymers, | | | | | |
| Polyesters, or Fillers | | | | | |

TABLE 4
Test Results

| Treatment Solutions | Acid Value (AV) | Amine Value | Drop Point (° C.) |
|---|---|---|---|
| E7 | 7.8 | 15.5 | 120.1 |
| E8 | 8.1 | 16.6 | 119.3 |
| E9 | 9.5 | 15.2 | 120.1 |
| E10 | 8.7 | 15.2 | 121.0 |
| E11 | 9.2 | 14.5 | 117.9 |

As can be seen, the test parameters were used for detecting quality of product and repeatability of the manufacturing process, especially with regard to acid value, amine value, and drop point.

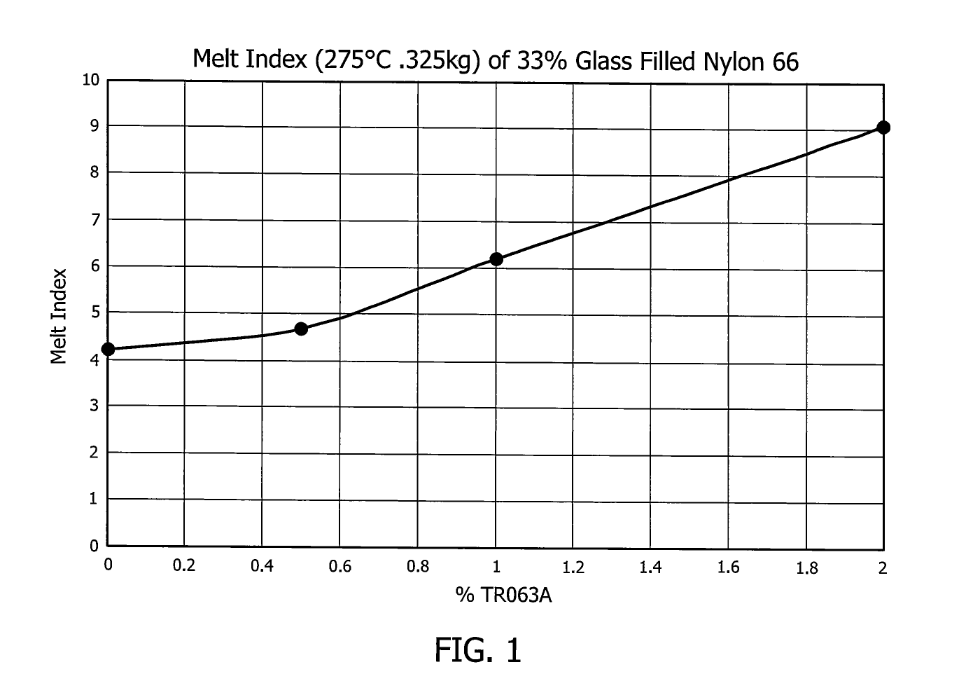

FIG. 1 illustrates a graph of the Melt Index (MI) of the composition as claimed, or the measure of the ease of flow of the melt of a thermoplastic polymer. Here, a small amount of the composition (33% Glass Filled Nylon 66®) was placed in the extruder. The sample was then preheated for a specified amount of time at 275° C. After the preheating, a specified weight of 0.325 kg was introduced. The weight exerts a force on the molten polymer and it immediately starts flowing through the die. A sample of the melt is taken after desired periods of time and is weighed accurately. MI is expressed as grams of polymer/10 minutes of flow time. Here, at 0% the composition exhibited a MI of 4.22, at 0.5% the composition exhibited a MI of 4.7, at 1.0% the composition exhibited a MI of 6.2, and at 2.0% the composition exhibited a MI of 9.1.

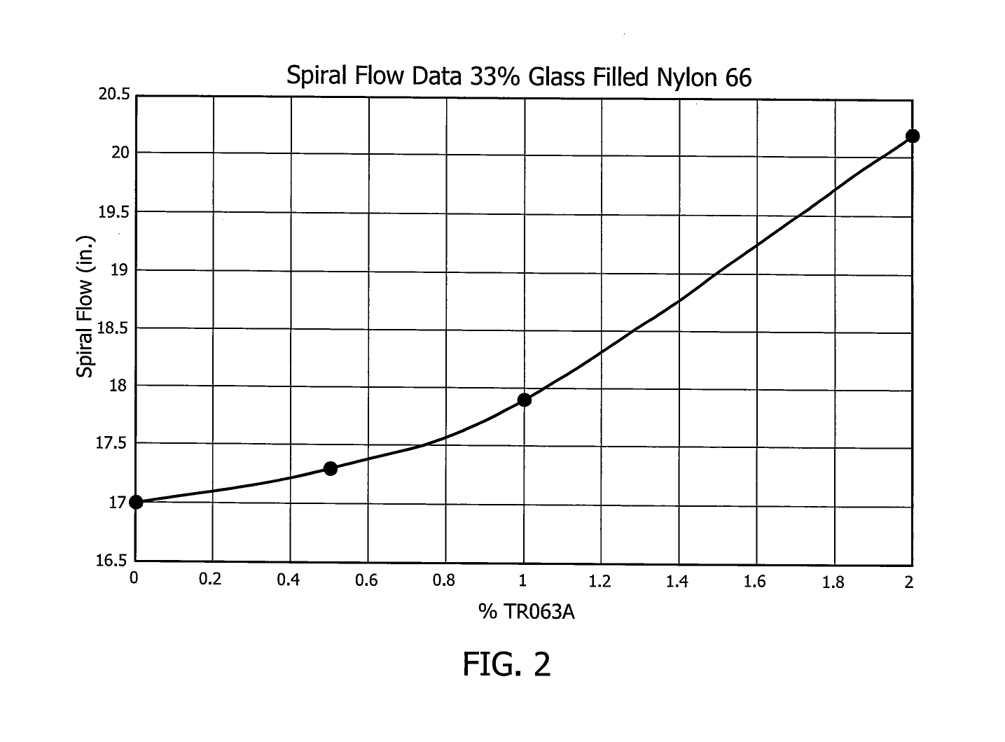

FIG. 2 illustrates a graph of the Spiral Flow Data of the composition as claimed. The spiral flow of a composition is a measure of the combined characteristics of fusion under pressure, melt viscosity, and gelation rate under specific conditions. The Spiral Flow test is a method for finding flow properties of either thermoplastic or themosetting resin, formulated by the distance it will flow under specified pressure and temperature and along a spiral runner. The test is usually performed using an injection molding machine and a test mold into which material is fed at the center of the spiral cavity. The composition (33% Glass Filled Nylon 66®) was placed in the spiral runner of the injection molding machine and the spiral flow data was measured. Here, at 0% the composition exhibited a spiral flow of 17 inches, at 0.5% the composition exhibited a spiral flow of 17.3 inches, at 1.0% the composition exhibited a spiral flow of 17.9 inches, and at 2.0% the composition exhibited a spiral flow of 20.18 inches.

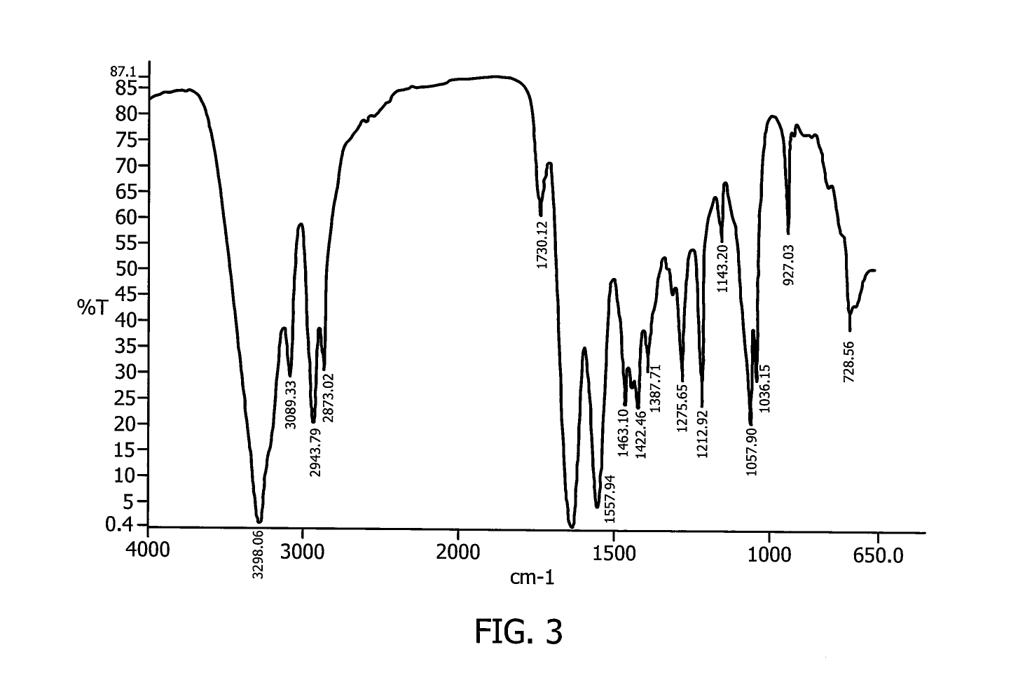

FIG. 3 illustrates a graph of an infrared spectrum of the composition as claimed. This graph depicts a characteristic of O—H peaks at 3298, a characteristic of C—H peaks between 2800-2900, a characteristic of a C═O stretch of an amide at 1600, and a characteristic of a N—H peak at 1557.

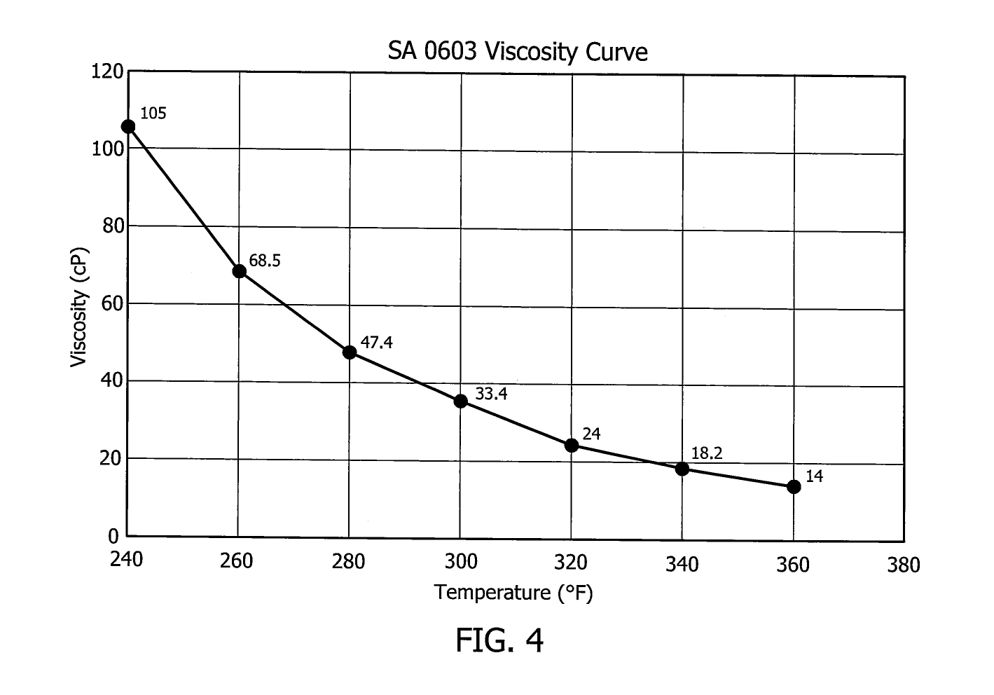

FIG. 4 illustrates a graph of a viscosity curve of the composition as claimed. Viscosity is an indicator of the resistance to flow. The composition as claimed decreases in viscosity (thickness) as the temperature increases.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A polymer additive composition comprising:
an amount of:
dicarboxylic acid; and an amine.

2. The composition of claim 1, wherein the dicarboxylic acid is adipic acid.

3. The composition of claim 1, wherein the amine is monoethanolamine.

4. The composition of claim 1, further comprising at least one of the following: amides, esters, antioxidants, waxes, metal soaps, copolymers, polyesters, or fillers.

5. The composition of claim 2, wherein amount of adipic acid in the composition is between about 30-65% by weight.

6. The composition of claim 3, wherein amount of monoethanolamine in the composition is between about 35-55% by weight.

7. The composition of claim 4, wherein amount of at least one of the following: amides, esters, antioxidants, waxes, metal soaps, copolymers, polyesters, or fillers in the composition is between about 0.5-15% by weight.

8. The composition of claim 1, wherein reaction temperature is between approximately 280°-420° F.

9. The composition of claim 1, wherein the composition is extruded at between approximately 250°-400° F.

10. The composition of claim 1, wherein the dicarboxylic acid comprises a molecular weight of about 118 to 174, and the amine comprises a molecular weight of about 61 to 145.

11. A method of making a polymer additive, comprising:
adding an amine to a cold reactor;
starting nitrogen flow;
mixing the amine;
adding an amount of dicarboxylic acid;
setting product temperature at approximately 300° F.;
keeping condenser on top of reactor;
gradually increasing temperature to approximately 360° F.;
running reaction through condenser;
keeping reaction temperature at approximately 360° F.;
running reaction until acid value is less than approximately 10; and
extruding product at approximately 260-280° F.

12. The method of claim 11, wherein the condenser is kept on top of the reactor for a first hour of reaction.

13. The method of claim 12, further comprising: adding an amount of at least one of the following: amides, esters, antioxidants, waxes, metal soaps, copolymers, polyesters, or fillers before extruding the product at approximately 260°-280° F.

14. The method of claim 11, wherein the dicarboxylic acid is adipic acid.

15. The method of claim 11, wherein the amine is monoethanolamine.

16. The method of claim 14, wherein amount of adipic acid in the reaction is between about 30-65% by weight.

17. The method of claim 15, wherein amount of monoethanolamine in the reaction is between about 35-55% by weight.

18. The method of claim 13, wherein amount of at least one of the following: amides, esters, antioxidants, waxes, metal soaps, copolymers, polyesters, or fillers in the composition is between about 0.5-15% by weight.

19. The method of claim 11, wherein the dicarboxylic acid comprises a molecular weight of about 118 to 174.

20. The method of claim 11, wherein the amine comprises a molecular weight of about 61 to 145.
